(19) United States
(12) Patent Application Publication
(10) Pub. No.: US 2025/0182527 A1
(43) Pub. Date: Jun. 5, 2025

(54) INFORMATION PROCESSING APPARATUS AND INFORMATION PROCESSING METHOD

(71) Applicant: CANON KABUSHIKI KAISHA, Tokyo (JP)

(72) Inventors: Shuhei TOBA, Kanagawa (JP); Hideaki MIZOBE, Kanagawa (JP); Yoshihiko IWASE, Kanagawa (JP)

(21) Appl. No.: 18/957,977

(22) Filed: Nov. 25, 2024

(30) Foreign Application Priority Data
Nov. 30, 2023 (JP) 2023-203331

(51) Int. Cl. G06V 40/18; G06T 7/00

(52) U.S. Cl. CPC G06V 40/18; G06T 7/0012; G06T 2207/10081; G06T 2207/10088

(57) ABSTRACT

Provided is an information processing apparatus including: an elongation information acquisition unit configured to acquire information regarding an elongation state of an eyeball to be analyzed; a data acquisition unit configured to acquire data including information regarding a thickness of a retinal layer of the eyeball; and an analysis unit configured to analyze an abnormality in the thickness of the retinal layer based on the information regarding the elongation state and the data including the information regarding the thickness of the retinal layer. The analysis unit includes a trained model configured to use, as input, at least the data including the information regarding the thickness of the retinal layer to output information regarding the abnormality in the thickness of the retinal layer.

### BACKGROUND OF THE INVENTION

### Field of the Invention

The present invention relates to an information processing apparatus and an information processing method.

### Description of the Related Art

A tomographic image acquisition apparatus using optical coherence tomography (OCT) is known. With such a tomographic image acquisition apparatus, a fundus of an eye can be photographed to acquire a group of tomographic images, and a state inside a retinal layer can be observed in a three-dimensional manner.

A technology for measuring a thickness of a specific retinal layer in an acquired tomographic image to create a map image (hereinafter referred to as “retinal layer thickness map”) in which information indicating the measured thickness is projected onto a plane along the fundus of the eye is known. The retinal layer thickness map has been attracting attention in recent years as an image with which a degree of progression of a disease such as glaucoma and a degree of recovery after treatment can be quantitatively diagnosed.

In addition, utilization of information regarding an elongation state of an eyeball, such as a visual acuity and an ocular axial length, which is important information for observation of a state inside the retinal layer, has also been advanced. For example, in Japanese Patent Application Laid-Open No. 2018-020192, a technology for switching a statistical database in accordance with the ocular axial length to calculate a degree of abnormality in a thickness of a retinal layer is disclosed.

In the technology as described in Japanese Patent Application Laid-Open No. 2018-020192, it is required to provide a step of switching the statistical database in accordance with the ocular axial length, and it is further required to provide classes based on the ocular axial length for the statistical database in advance. Thus, it is desired to be able to efficiently analyze an abnormality in the thickness of the retinal layer.

### SUMMARY OF THE INVENTION

The present invention has been made in order to solve the above-mentioned problem.

That is, according to one aspect of the present invention, there is provided an information processing apparatus including: an elongation information acquisition unit configured to acquire information regarding an elongation state of an eyeball to be analyzed; a data acquisition unit configured to acquire data including information regarding a thickness of a retinal layer of the eyeball; and an analysis unit configured to analyze an abnormality in the thickness of the retinal layer based on the information regarding the elongation state and the data including the information regarding the thickness of the retinal layer. The analysis unit includes a trained model configured to use, as input, at least the data including the information regarding the thickness of the retinal layer to output information regarding the abnormality in the thickness of the retinal layer.

Further, according to another aspect of the present invention, there is provided an information processing method including: an elongation information acquisition step of acquiring information regarding an elongation state of an eyeball to be analyzed; a data acquisition step of acquiring data including information regarding a thickness of a retinal layer of the eyeball; and an analysis step of analyzing an abnormality in the thickness of the retinal layer based on the information regarding the elongation state and the data including the information regarding the thickness of the retinal layer. The analysis step includes using a trained model configured to use, as input, at least the data including the information regarding the thickness of the retinal layer to output information regarding the abnormality in the thickness of the retinal layer.

Further, according to still another aspect of the present invention, there is provided a non-transitory storage medium having stored thereon a program for causing a computer to execute the above-mentioned information processing method.

Further features of the present invention will become apparent from the following description of exemplary embodiments with reference to the attached drawings.

### BRIEF DESCRIPTION OF THE DRAWINGS

FIG. 1 is a functional block diagram of an information processing system including an information processing apparatus according to a first embodiment.

FIG. 2 is a block diagram for illustrating a hardware configuration of the information processing system including the information processing apparatus according to the first embodiment.

FIG. 3 is a flow chart for illustrating an example of a processing procedure in the first embodiment.

FIG. 4 is a schematic view for illustrating an example of display of an abnormality degree map in the first embodiment.

FIG. 5 is a schematic view for illustrating an example of display of an abnormality degree map in Modification Example 3 of the first embodiment.

FIG. 6 is a flow chart for illustrating an example of a processing procedure in a second embodiment.

FIG. 7 is a schematic diagram for illustrating an example of distributions of ocular axial lengths included in trained models in the second embodiment.

FIG. 8 is a flow chart for illustrating an example of a processing procedure in a third embodiment.

FIG. 9 is a conceptual diagram for illustrating an example of training of an abnormality detection model.

FIG. 10 is a conceptual diagram for illustrating an example of generating a feature extractor in a class classification model.

FIG. 11 is a conceptual diagram for illustrating an example of generating a feature extractor in an image generation model.

FIG. 12 is a conceptual diagram for illustrating an example of the training of the abnormality detection model in the first embodiment.

FIG. 13 is a conceptual diagram for illustrating an example of generating a feature extractor of the abnormality detection model in the first embodiment.

FIG. 14 is a conceptual diagram for illustrating a calculation method for the abnormality degree map in the abnormality detection model in the first embodiment.

FIG. 15 is a conceptual diagram for illustrating an example of training of a segmentation model in the first embodiment.

FIG. 16 is a conceptual diagram for illustrating an example of training of an abnormality detection model in Modification Example 1 of the first embodiment.

FIG. 17 is a conceptual diagram for illustrating an example of training of a class classification model in Modification Example 3 of the first embodiment.

FIG. 18 is a schematic diagram for illustrating an example of distributions of ocular axial lengths and distributions of visual acuities that are included in trained models in Modification Example 1 of the second embodiment.

### DESCRIPTION OF THE EMBODIMENTS

Embodiments are described in detail below with reference to the attached drawings. The embodiments described below do not limit the present invention set forth in the appended claims. A plurality of features are described in the embodiments, but the present invention does not necessarily require all of those plurality of features, and a plurality of features may be combined as appropriate. Further, in the attached drawings, the same or similar components are denoted by the same reference symbols, and redundant description thereof is sometimes omitted.

### First Embodiment

An information processing apparatus according to this embodiment acquires information regarding an elongation state of an eyeball to be analyzed and data including information regarding a thickness of a retinal layer of the eyeball. Then, the information processing apparatus analyzes an abnormality in the thickness of the retinal layer through use of a trained model based on the above-mentioned information regarding the elongation state and the above-mentioned data including the information regarding the thickness of the retinal layer. This enables efficient analysis of an abnormality in the thickness of the retinal layer.

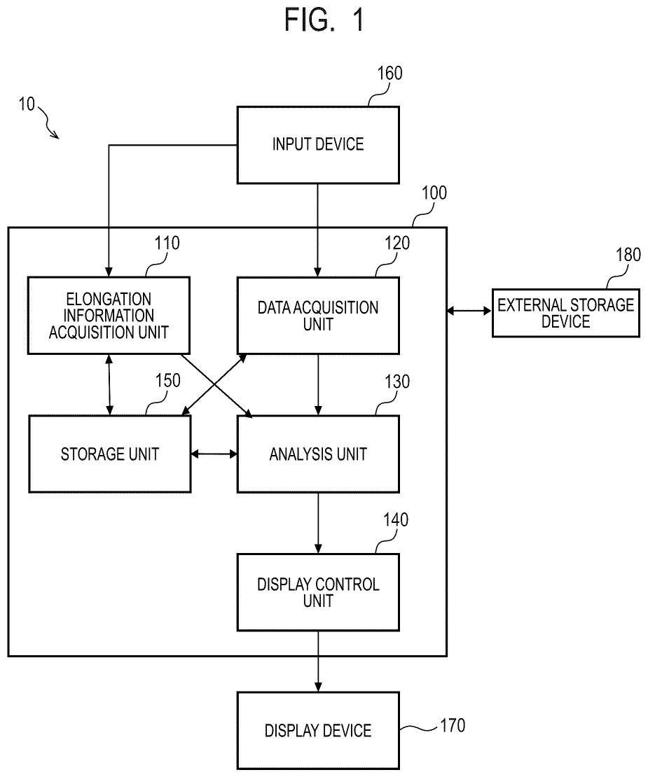

FIG. 1 is a functional block diagram of an information processing system 10 including an information processing apparatus 100 according to the first embodiment. The information processing apparatus 100 includes, as functional components thereof, an elongation information acquisition unit 110, a data acquisition unit 120, an analysis unit 130, a display control unit 140, and a storage unit 150. The information processing system 10 includes the information processing apparatus 100 and also includes an input device 160, a display device 170, and an external storage device 180, which are each connected to the information processing apparatus 100.

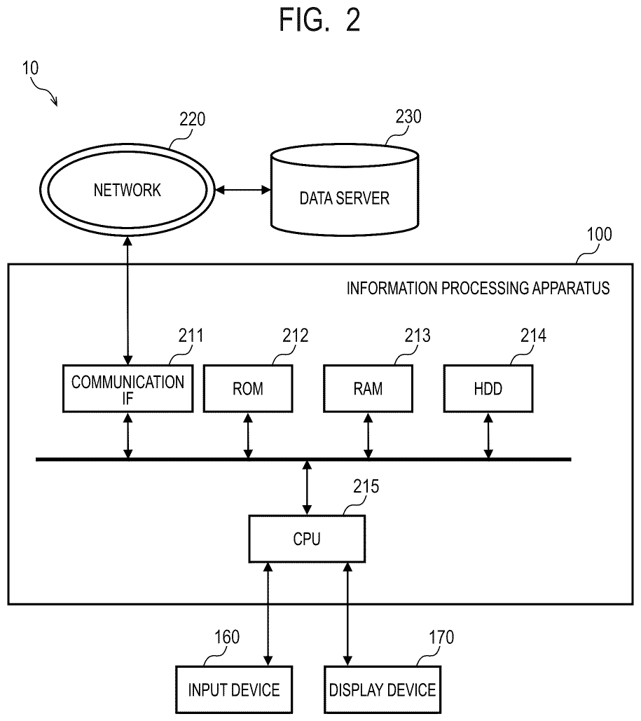

FIG. 2 is a block diagram for illustrating a hardware configuration of the information processing system 10 including the information processing apparatus 100 according to the first embodiment. The information processing system 10 includes the information processing apparatus 100, a network 220, a data server 230, the input device 160, and the display device 170. The information processing apparatus 100 is connected to the data server 230 so as to enable communication therebetween through the network 220. The network 220 includes, for example, a local area network (LAN) or a wide area network (WAN).

The data server 230 that implements a function of the external storage device 180 holds and manages the information regarding the elongation state of an eyeball, the data including the information regarding the thickness of the retinal layer of the eyeball, and information regarding a trained model. The information processing apparatus 100 acquires, through the network 220, various kinds of data held on the data server 230. The function of the data server 230 that implements the function of the external storage device 180 as described herein can also be implemented by the storage unit 150. In the same manner, the function of the storage unit 150 as described herein can also be implemented by the external storage device 180 such as the data server 230.

In this embodiment, as the data including the information regarding the thickness of the retinal layer, a retinal layer thickness map is used. The data including the information regarding the thickness of the retinal layer is not limited thereto, and may be an optical coherence tomographic image (OCT image) or retinal layer segmentation data. The data including the information regarding the thickness of the retinal layer may also be an image of an eyeball photographed by a magnetic resonance imaging (MRI) apparatus or a computed tomography (CT) apparatus.

The retinal layer thickness map has several types depending on a layer structure to be subjected to thickness measurement. In this embodiment, a retinal layer thickness map obtained by measuring a thickness from a Bruch's membrane to an internal limiting membrane is used, but the present invention is not limited thereto, and a retinal layer thickness map obtained by measuring a thickness from an inner plexiform layer to the internal limiting membrane or the like may be used.

In this embodiment, as the information regarding the elongation state of the eyeball, an ocular axial length measured by an ocular axial length measuring apparatus or an OCT apparatus is used, but the present invention is not limited thereto, and a visual acuity measured by a visual acuity test, a refractive power measured by an objective refraction test (refractometer), or the like may be used.

Further, the information regarding the trained model includes a network structure, weight information, and information regarding the training data, of the trained model that uses, as input, the data including the information regarding the thickness of the retinal layer and the information regarding the elongation state of the eyeball to output information regarding the abnormality in the thickness of the retinal layer. The information regarding the training data is information such as: a distribution and a range regarding the elongation state included in training information regarding the elongation state of the eyeball used for training of the trained model; and a type of the data including the information regarding the thickness of the retinal layer. Those piece of information are stored in association with the network structure and the weight information.

The information processing apparatus 100 has a function of displaying, on the display device 170, a result of analyzing an abnormality in the thickness of the retinal layer, and has a function of receiving an operation performed by a user such as a doctor. The information processing apparatus 100 includes a communication interface (IF) 211 (communication unit), a read only memory (ROM) 212, a random access memory (RAM) 213, a hard disk drive (HDD) 214, and a central processing unit (CPU) 215, and is connected to the input device 160 and the display device 170.

The communication IF 211 (communication unit) is formed of a LAN card or the like, and implements communication between an external device (for example, the data server 230 that implements the function of the external storage device 180) and the information processing apparatus 100. The ROM 212 is formed of a nonvolatile memory or the like, and stores various programs. The RAM 213 is formed of a volatile memory or the like, and temporarily stores various kinds of information as data. The hard disk drive (HDD) 214 that implements the function of the storage unit 150 stores various kinds of information as data.

The input device 160 is formed of a graphical user interface (GUI) such as a keyboard, a mouse, or a touch panel, and is a device for inputting an instruction from a user (for example, a doctor) to the information processing apparatus 100. The information regarding the elongation state of the eyeball and the data including the information regarding the thickness of the retinal layer to be subjected to processing are input to the information processing apparatus 100 in accordance with an instruction of the user who operates the input device 160. Selection of the data to be subjected to the processing is not required to be performed based on an instruction of the user, and, for example, the elongation information acquisition unit 110 or the data acquisition unit 120 of the information processing apparatus 100 may be configured to automatically select the data to be subjected to the processing based on a predetermined rule.

The elongation information acquisition unit 110 acquires the information regarding the elongation state of the eyeball from the data server 230 through the communication IF 211 (communication unit) and the network 220.

The data acquisition unit 120 acquires the data including the information regarding the thickness of the retinal layer, which is associated with the information regarding the elongation state of the eyeball, from the data server 230 through the communication IF 211 (communication unit) and the network 220.

The communication IF 211 is a communication device based on a standard such as Wi-Fi (trademark), Ethernet (trademark), or Bluetooth (trademark).

The analysis unit 130 analyzes an abnormality in the thickness of the retinal layer based on the information regarding the elongation state of the eyeball and the data including the information regarding the thickness of the retinal layer. Further, the analysis unit 130 also includes a trained model that uses, as input, at least the data including the information regarding the thickness of the retinal layer to output the information regarding the abnormality in the thickness of the retinal layer.

A result obtained through analysis of an abnormality in the thickness of the retinal layer by the analysis unit 130 can include at least any one selected from the group consisting of a map image indicating a degree of abnormality in the thickness of the retinal layer, a true or false value indicating the presence or absence of a disease, a scalar value indicating a possibility of having a disease, and thickness data of the retinal layer expected to be obtained when the thickness of the retinal layer is normal. In this embodiment, the map image (hereinafter referred to as “abnormality degree map”) indicating a degree of abnormality in a retinal layer thickness is used as the result obtained through the analysis by the analysis unit 130.

The display control unit 140 performs control for displaying, on the display device 170, a result of the analysis performed by the analysis unit 130.

The display device 170 is formed of any device such as an LCD or a CRT, and displays, to the user, an image or the like relating to an analysis result acquired from the information processing apparatus 100 and various kinds of information.

Each of the components of the information processing apparatus 100 described above functions in accordance with a computer program. For example, the CPU 215 reads in and executes a computer program stored in the ROM 212 or the HDD 214, which is a nonvolatile storage medium, with the RAM 213, which is a volatile storage medium, being used as a work area, to thereby implement the functions of the respective components. Some or all of the functions of the components of the information processing apparatus 100 may be implemented through use of a dedicated circuit. In addition, some of the functions implemented by the CPU 215 (for example, the function of the analysis unit 130) may be implemented through use of a cloud computer.

For example, an arithmetic device located at a place different from the information processing apparatus 100 may be connected to the information processing apparatus 100 so as to enable communication therebetween through the network 220, and the information processing apparatus 100 and the arithmetic device may transmit and receive data, to thereby implement the functions of components of the information processing apparatus 100. The functions of the components of the information processing apparatus 100 can also be implemented by a circuit (for example, ASIC) that implements one or more of the functions.

The above-mentioned configuration of the information processing apparatus 100 is merely an example, and can be changed as appropriate. Examples of a processor that can be mounted in the information processing apparatus 100 include a GPU, an ASIC, and an FPGA in addition to the above-mentioned CPU 215. In addition, a plurality of those processors may be provided, or a plurality of processors may perform processing in a distributed manner. Further, the HDD 214 may be a storage medium such as an optical disc, a magneto-optical disk, or a solid state drive (SSD).

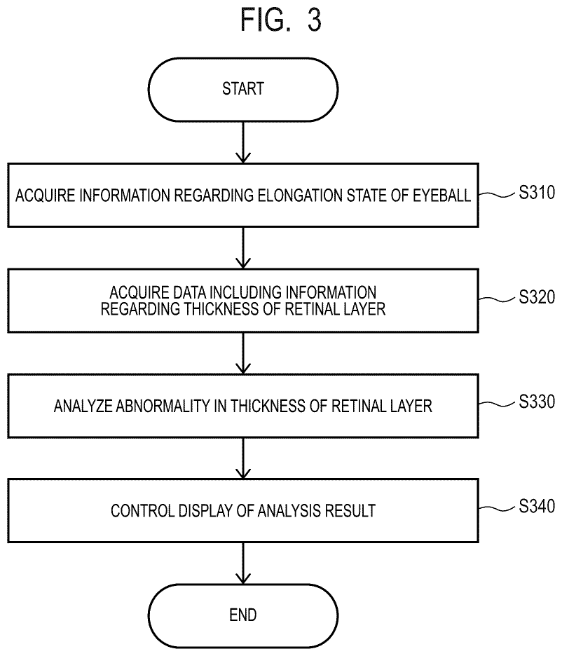

Next, an example of processing to be performed by the information processing apparatus 100 is described with reference to FIG. 3. FIG. 3 is a flow chart for illustrating an example of a procedure of processing of an information processing method to be performed by the information processing apparatus 100. In this embodiment, an example in which the ocular axial length is acquired as the information regarding the elongation state of the eyeball, the retinal layer thickness map is acquired as the data including the information regarding the thickness of the retinal layer, and the abnormality degree map is obtained as the result of analyzing an abnormality in the thickness of the retinal layer is described.

### (Step S310: Elongation Information Acquisition Step)

In an elongation information acquisition step of Step S310, the elongation information acquisition unit 110 acquires the information regarding the elongation state of the eyeball to be analyzed. In this embodiment, the elongation information acquisition unit 110 receives designation of a subject, which has been input by the user through the input device 160, and acquires information on the ocular axial length of the subject designated by the user from the data server 230. The information on the ocular axial length is a scalar value indicating a length from a cornea to a retina.

A method of acquiring the information on the ocular axial length is not limited to a method of acquiring the scalar value recorded on the data server 230. For example, an image of the subject photographed by an OCT apparatus, an MRI apparatus, a CT apparatus, or the like may be acquired from the data server 230 to calculate the information on the ocular axial length by a publicly known image analysis technology.

### (Step S320: Data Acquisition Step)

In a data acquisition step of Step S320, the data acquisition unit 120 acquires the data including the information regarding the thickness of the retinal layer of the eyeball to be analyzed. In this embodiment, the data acquisition unit 120 acquires, from the data server 230, the retinal layer thickness map of the subject, which has been designated by being input by the user through the input device 160.

A method of acquiring the retinal layer thickness map is not limited to a method of acquiring the retinal layer thickness map recorded on the data server 230. For example, an OCT image of the subject is acquired from the data server 230, and segmentation processing of the retinal layer is performed on the OCT image by a publicly known image analysis technology, to thereby acquire the retinal layer segmentation data. Then, the retinal layer thickness map may be calculated from the retinal layer segmentation data. Further, the retinal layer segmentation data of the subject, which is held on the data server 230, may be acquired to calculate the retinal layer thickness map from the retinal layer segmentation data.

### (Step S330: Analysis Step)

In an analysis step of Step S330, the analysis unit 130 analyzes an abnormality in the thickness of the retinal layer based on the information regarding the elongation state, which has been acquired in Step S310, and the data including the information regarding the thickness of the retinal layer, which has been acquired in Step S320. The analysis step of Step S330 includes using a trained model that uses, as input, at least the data including the information regarding the thickness of the retinal layer, which has been acquired in Step S320, to output the information regarding the abnormality in the thickness of the retinal layer. In this embodiment, the analysis unit 130 inputs the information on the ocular axial length, which has been acquired in Step S310, and the retinal layer thickness map, which has been acquired in Step S320, to the trained model to output the abnormality degree map on the thickness of the retinal layer. The abnormality degree map is a map representing the degree of abnormality in the thickness of the retinal layer in correspondence with the retinal layer thickness map.

In this embodiment, an example of acquiring the information on the ocular axial length and the retinal layer thickness map as the information regarding the elongation state of the eyeball and the data including the information regarding the thickness of the retinal layer, respectively, has been described, but the present invention is not limited thereto. In accordance with a type of the acquired information regarding the elongation state of the eyeball and a type of the acquired data including the information regarding the thickness of the retinal layer, the analysis unit 130 selects, from the data server 230, the trained model that uses those types as input.

### (Abnormality Detection Model)

In this case, for example, an abnormality detection model can be used as the trained model for outputting the abnormality degree map. The abnormality detection model is a model that learns a distribution of measurement data of a subject having a retinal layer having a normal thickness and calculates, as the abnormality degree, a degree of divergence (distance) between the data to be analyzed relating to the input and the learned distribution. For example, a model based on a publicly known abnormality detection model such as PaDiM or PatchCore and trained with the information on the ocular axial length and the retinal layer thickness map that have been acquired from the subject having a retinal layer having a normal thickness, can be used.

When the abnormality detection model such as PaDiM or PatchCore is adopted as a base, the model is required to be modified. Training and inference methods in a case of adopting PatchCore are described below.

### (Training of PatchCore)

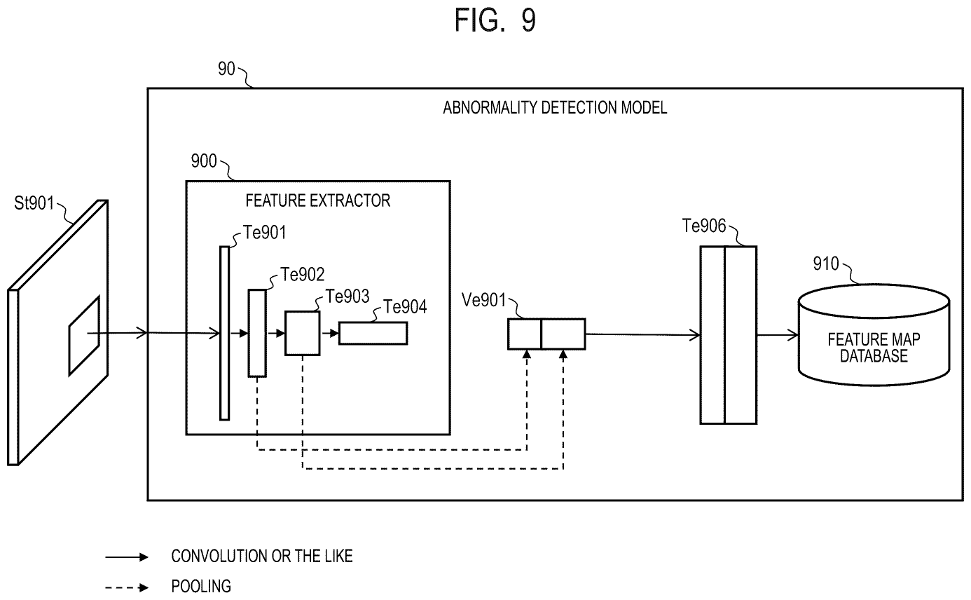

First, a method of training an abnormality detection model 90 based on PatchCore is described with reference to FIG. 9.

In the training of PatchCore, processing for extracting a feature vector Ve901 by inputting a small region (patch) of training image data St901 to a feature extractor 900 is performed.

### (Training of PatchCore: Regarding Feature Extractor)

In this case, the feature extractor 900 can be generated by extracting a part of a network structure and parameters based on a trained network model trained through use of a publicly known data set.

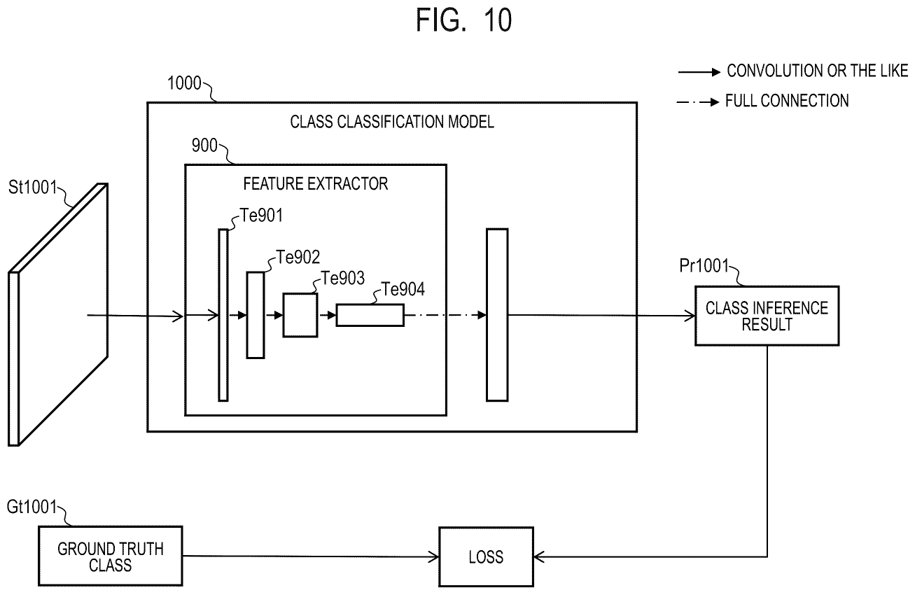

FIG. 10 is a conceptual diagram for illustrating an example of generating a feature extractor in a trained model for performing class classification. A class classification model 1000 outputs an inference result Pr1001 for each class through operations of a plurality of convolutions and a full connection from an input image St1001. The inference result Pr1001 is a vector having, as an element, a likelihood indicating which class the input belongs to. In the training of the class classification model, an error (loss) between a ground truth class Gt1001 in the training data and the inference result Pr1001 is calculated, and parameters in the operations such as convolutions are optimized by an error back-propagation method so as to minimize the loss. The loss can be obtained through use of, for example, a general method in which the ground truth class Gt1001 is converted into a vector by one-hot encoding and then a cross entropy error is calculated.

In PatchCore, the network structure and parameters up to the final convolutional layer in the thus optimized trained model are extracted to be used as the feature extractor 900. As a specific example of the data set or the network model to be used to generate a feature extractor, for example, ResNet trained so as to perform class classification through use of an ImageNet data set can be used.

The network model to be used as a base of the feature extractor is not limited to a ResNet that performs the class classification, and any network model that has a configuration for outputting a tensor representing an image feature through a plurality of convolutional layers may be used. For example, an encoder unit of an AutoEncoder, which is a type of an image generation model, can be used as the feature extractor.

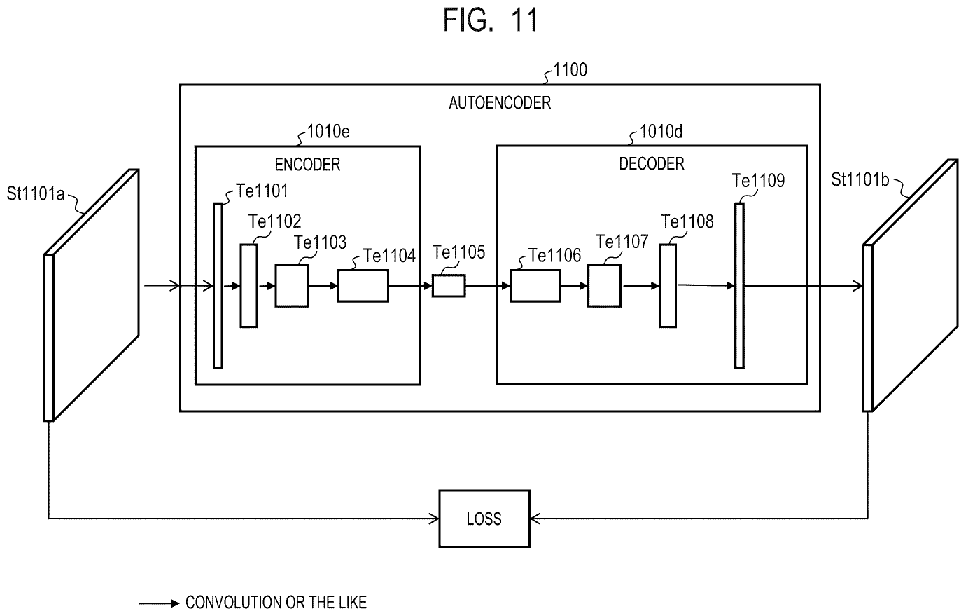

FIG. 11 is a conceptual diagram for illustrating a network structure of the AutoEncoder and a training method therefor. The AutoEncoder includes an encoder unit 1010e that extracts an image feature from an input image and a decoder unit 1010d that attempts to restore the same image as that of the input from the image feature. The encoder unit 1010e outputs, from an input image St1101a, a tensor Te1105, which is a tensor indicating an image feature, through a plurality of convolutions. In this case, tensors Te1101 to Te1104 are tensors generated in intermediate layers of the encoder unit 1010e. After that, the decoder unit 1010d uses a tensor Te1105 as input to output a restored image St1101b through a plurality of convolutions. In this case, tensors Te1106 to Te1109 are tensors generated in intermediate layers of the decoder unit 1010d. In the training of the AutoEncoder, a loss is calculated based on the input image St1101a and the restored image St1101b, and parameters in the operations such as convolutions are optimized by the error back-propagation method so as to minimize the loss. The loss can be obtained by a common method or the like using an index such as a mean square error (MSE).

In PatchCore, the network structure and parameters of the encoder unit 1010e of an AutoEncoder 1100 trained as described above can be extracted to be used as the feature extractor 900 as well.

### (Training of PatchCore: Calculation of Feature Map)

The feature vector Ve901 is generated by extracting tensors generated in the intermediate layers of the feature extractor 900 and connecting the tensors through pooling processing. The “tensors generated in the intermediate layers” as used herein correspond to the tensors Te901 to Te904 of FIG. 9. In the example of FIG. 9, the tensors Te902 and Te903 are extracted, but there may be, for example, a form in which only the tensor Te903 or the tensors Te901 to Te903 are extracted.

The above-mentioned feature vector extraction processing is applied to each patch of the image to generate a tensor Te906 indicating a feature map that is a set of feature vectors corresponding to positions of respective pixels.

In the training of PatchCore, the tensor Te906 is generated based on the training data formed of data of the retinal layer thickness map obtained from a retinal layer having a normal thickness, and is held in a feature map database 910.

The training method for PatchCore in a case of using PatchCore as the example of the model serving as the base of the abnormality detection model that is used in this embodiment has been described above.

### (Training of the Abnormality Detection Model in This Embodiment)

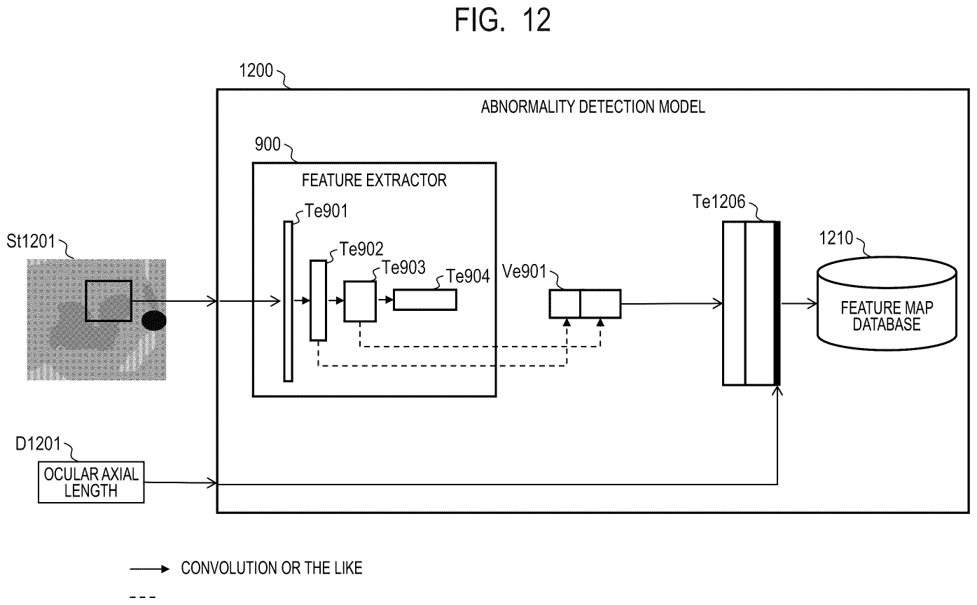

A training method for the abnormality detection model that is used in this embodiment is described with reference to FIG. 12.

In the training of the abnormality detection model that is used in this embodiment, a feature map in which a scalar value D1201 indicating the information on the ocular axial length associated with the retinal layer thickness map used for the training is provided to the tensor Te906 extracted from an input image St1201 in the above-mentioned manner is generated. As a specific method of providing the scalar value D1201, for example, a case in which a shape of the original tensor Te906 exhibited before the scalar value D1201 is provided is a shape of “N×H×W” is assumed. In this expression, N represents the number of dimensions of the feature vector Ve901, H represents a height, and W represents a width. In a case of this shape, processing for generating a tensor Te1206 by extending the tensor Te906 to a shape of “(N+1)×H×W” in terms of the number of channels and for filling in a value of the extended tensor region with the scalar value D1201 is added.

In some cases, a network model that normalizes and handles input and output tensors is used in order to increase accuracy of the abnormality degree map (likelihood of the calculated abnormality) and calculation efficiency. For example, a value range of a tensor generated by the network model may be a range of from −10.0 to 10.0 or the like. Meanwhile, for example, a value of the scalar value indicating the ocular axial length may be a value such as 25 millimeters different from the value range of the tensor. In such a case, when the scalar value indicating the ocular axial length that is a value different from the value range of the tensor is provided with respect to the value range of the tensor generated by the network model, the model may be trained to have low accuracy of the abnormality degree map. Thus, the scalar value may be normalized, and may be, for example, converted into a value of from 0 to 1 by being divided by a maximum value that can be input to the abnormality detection model.

In the abnormality detection model that is used in this embodiment, the tensor Te1206 is generated based on the training data formed of the data of the retinal layer thickness map obtained from a retinal layer having a normal thickness, and is held in the feature map database 910.

### (Variation of Training of Feature Extractor)

The generated feature extractor 900 is not limited to that generated from the trained model trained by the data set such as ImageNet. For example, the feature extractor 900 may be generated by transfer learning with the retinal layer thickness map being used as the training data for the network model serving as the base of the feature extractor 900.

It is also preferred to generate a feature extractor that uses, as input, the retinal layer thickness map and the information on the ocular axial length. In that case, it is required to modify the network model serving as the base of the feature extractor. For example, the AutoEncoder illustrated in FIG. 11 may be used as the base and modified so as to use, as input, the retinal layer thickness map and the information on the ocular axial length.

Specifically, during the training of the AutoEncoder 1100, the scalar value indicating the ocular axial length is provided to at least one tensor spatial axis among the number of channels, the height, and the width of at least one tensor. The tensor to which the scalar value indicating the ocular axial length is to be provided may be any one of a tensor generated in the intermediate layer of the encoder unit 1010e, a tensor output from the encoder unit 1010e, or a tensor generated in the intermediate layer of the decoder unit 1010d. A method of providing the scalar value is the same as the method described with reference to FIG. 12 for the training method for the abnormality detection model.

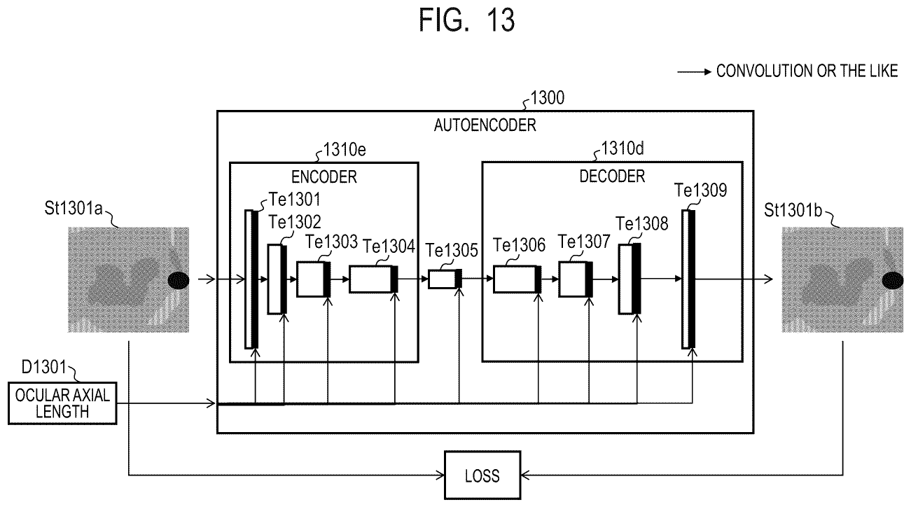

In FIG. 13, an example of training of a modified AutoEncoder is illustrated. An AutoEncoder 1300 includes an encoder unit 1310e and a decoder unit 1301e.

In the training of the AutoEncoder illustrated in FIG. 13, a loss is calculated based on an input image St1301a and a restored image St1301b, and parameters in the operations such as convolutions are optimized by the error back-propagation method so as to minimize the loss. In addition, in the training of the AutoEncoder 1300 illustrated in FIG. 13, tensors Te1301 to Te1309 are generated by providing a scalar value indicating an ocular axial length D1301 to all the tensors Te1101 to Te1109 in the AutoEncoder illustrated in FIG. 11. When the feature extractor that uses, as input, the retinal layer thickness map and the information on the ocular axial length is generated, the network structure and parameters of the encoder unit 1310e of the AutoEncoder 1300 can be extracted to be used as the feature extractor.

In FIG. 13, an example in which the scalar value is provided to all the tensors in the AutoEncoder has been described, but the present invention is not limited thereto, and there may be a form in which the scalar value is provided to the tensors Te1102 and Te1103, a form in which the scalar value is provided only to the tensor Te1103, or the like. A method of generating tensors indicating a feature map in a case of using the encoder unit 1310e as the feature extractor is equivalent to that in a case of replacing the feature extractor 900 of FIG. 9 by the feature extractor (encoder unit 1310e) that uses, as input, the retinal layer thickness map and the information on the ocular axial length. That is, the generation may be performed by extracting tensors generated in the intermediate layers of the feature extractor and connecting the tensors through pooling processing.

The training method for the abnormality detection model that is used in this embodiment has been described above.

### (Inference of Abnormality Detection Model)

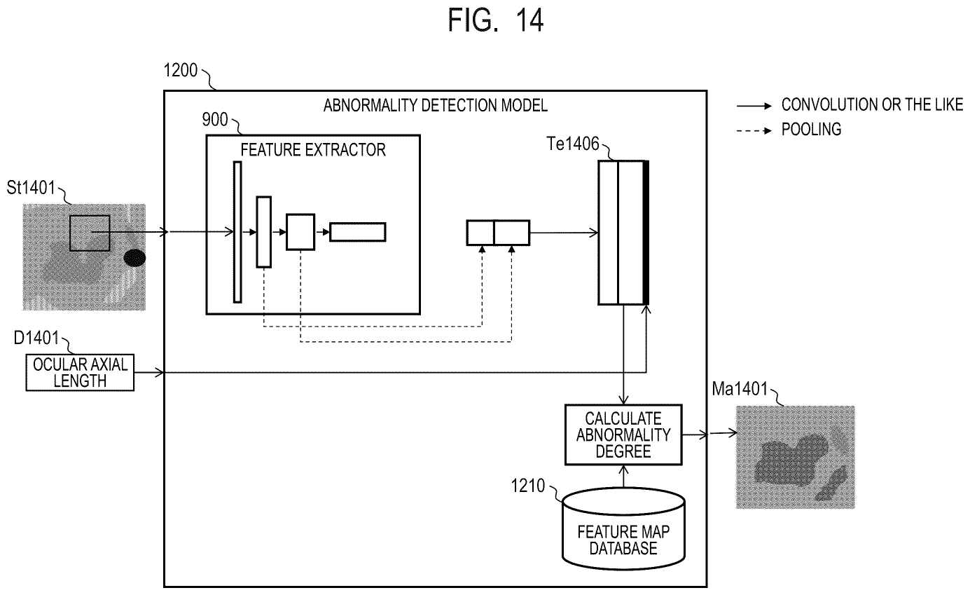

An example of using the abnormality detection model trained by the above-mentioned method and inputting thereto the retinal layer thickness map of the subject and the information on the ocular axial length to calculate the abnormality degree map is described with reference to FIG. 14.

FIG. 14 is an example of using, as input, a retinal layer thickness map St1401 and information D1401 on the ocular axial length to output an abnormality degree map Ma1401 on the thickness of the retinal layer.

A flow of generating a feature map from the retinal layer thickness map and the information on the ocular axial length that relate to the input is the same as a flow of generating the tensor Te1206, which is the feature map illustrated in FIG. 12. In FIG. 14, a tensor Te1406, which is a feature map obtained by providing a scalar value indicating the information D1401 on the ocular axial length to the feature map extracted from the retinal layer thickness map St1401, is generated.

After that, the abnormality degree map Ma1401 is generated by calculating the abnormality degree of the tensor Te1406, which is the feature map, based on a feature map group of retinal layer thickness maps regarding retinal layers having a normal thickness held in a feature map database 1210. In this case, as a calculation method for the abnormality degree, the same method as a calculation method for the abnormality degree map in PatchCore can be employed. Specifically, a distance between the feature map group in the feature map database 1210 and the feature vector calculated from the input information is calculated based on a neighborhood method to be set as the abnormality degree. An abnormality degree map is calculated by calculating and mapping abnormality degrees with respect to the feature vectors corresponding to the respective pixels.

The training method for the abnormality detection model and the calculation method for the abnormality degree map in the case of adopting the abnormality detection model as the trained model for outputting the abnormality degree map have been described above.

### (Segmentation Model)

The trained model for outputting the abnormality degree map is not limited to the abnormality detection model, and may be, for example, a segmentation model. The segmentation model is a model that uses, as input, the information on the ocular axial length and the retinal layer thickness map and has learned, as teacher data, mask images indicating abnormal regions in retinal layer thickness maps. For example, a publicly known segmentation model such as U-Net can be used.

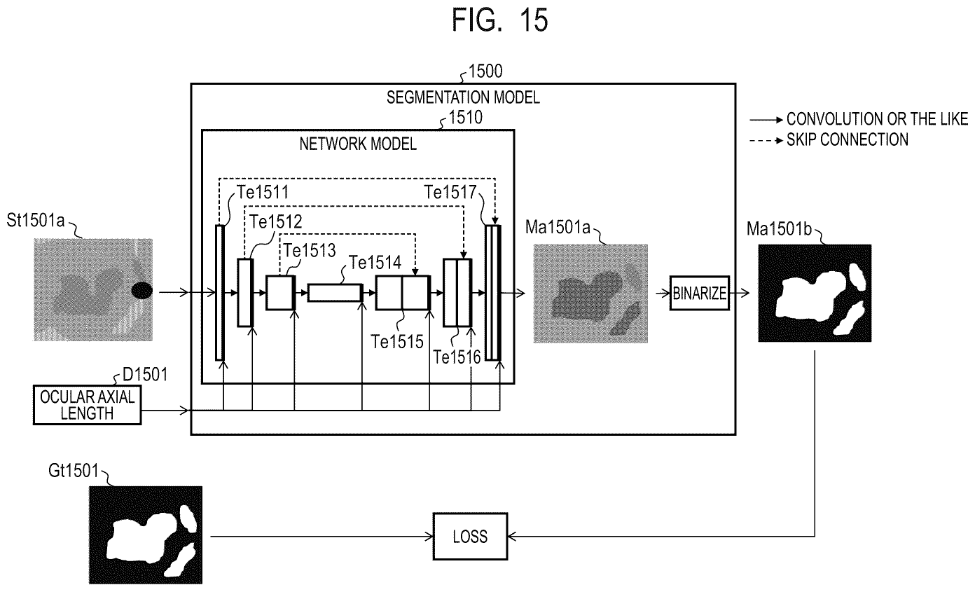

In a case of adopting U-Net, the model is required to be modified so as to use, as input, the retinal layer thickness map and the information on the ocular axial length. A modified U-Net architecture and a training method thereof are described below with reference to FIG. 15.

In general, there is a segmentation model that handles multiple classes such that each pixel of an input image is determined to be classified into any one of a plurality of classes. Unless otherwise specified, the segmentation model to be handled in this embodiment is assumed to handle two classes, namely, a pixel indicating a normal region or a pixel indicating an abnormal region.

A segmentation model 1500 receives a retinal layer thickness map St1501a as input, and outputs a mask image Ma1501b indicating an abnormal region.

In related-art U-Net, a probability map Ma1501a indicating a probability of whether or not each pixel is an abnormal region is output to the retinal layer thickness map St1501a, which is the input image, through the following operations. That is, the probability map Ma1501a is output to the retinal layer thickness map St1501a through operations such as a plurality of convolutions and an operation for connecting the tensors to each other by a skip connection. After that, a loss is calculated based on the mask image Ma1501b generated by binarization processing and a mask image Gt1501 indicating an abnormal region that is a ground truth, and parameters in the operations such as convolutions are optimized by the error back-propagation method so as to minimize the loss. The loss can be calculated by a general method or the like using an index such as a DICE score.

In contrast, in the model in this embodiment, as illustrated in FIG. 15, a scalar value D1501 indicating the ocular axial length is provided to tensors generated in intermediate layers of a network model 1510. Specifically, the scalar value D1501 indicating the ocular axial length is provided to at least one tensor spatial axis among the number of channels, the height, and the width of at least one tensor of the tensors generated in the intermediate layers of the network model 1510. A method of providing the scalar value is the same as the method described with reference to FIG. 12.

In the example illustrated in FIG. 15, the scalar value D1501 indicating the information on the ocular axial length is provided to all tensors of tensors Te1511 to Te1517. A method of providing the scalar value D1501 indicating the information on the ocular axial length is not limited thereto, and there may be, for example, a form in which the scalar value is provided to the tensors Te1512 and Te1513 or a form in which the scalar value is provided only to the tensor Te1513. As a method of calculating the loss and a method of optimizing parameters in the operations such as convolutions, the same method as that of related-art U-Net can be used.

In a case of adopting the segmentation model as the trained model for outputting the abnormality degree map, the information on the ocular axial length of the subject and the retinal layer thickness map are input to the model trained as described above, and a probability map calculated by the segmentation model is used as the abnormality degree map. Specifically, the segmentation model 1500 of FIG. 15 may be configured to output the probability map Ma1501a.

Instead of U-Net, a network model such as FCN or Mask R-CNN may be modified to be used. In those cases as well, the network model is configured to have tensors in intermediate layers provided with the information on the ocular axial length, and is trained, to thereby be able to generate a trained model that uses, as input, the retinal layer thickness map and the information on the ocular axial length.

In this case, the user may instruct, through the input device 160, whether to use the abnormality detection model or the segmentation model as the trained model for outputting the abnormality degree map. In that case, the information processing apparatus 100 may retrieve models for outputting the abnormality degree map from the data server 230, and display the models in a list format on the display device 170, and the user may select the trained model from the above-mentioned list.

### (Step S340: Display Control Step)

In a display control step of Step S340, the display control unit 140 performs control for displaying, on the display device 170, the result of the analysis performed by the analysis unit 130 in Step S330. In this embodiment, in the display control step of Step S340, the display control unit 140 performs control for displaying the abnormality degree map on the display device 170.

Specifically, in this embodiment, the display control unit 140 performs control for creating an abnormality degree heat map in which an image that shows the abnormality degree map is displayed such that a color is assigned to each pixel of the image in correspondence with the abnormality degree of the pixel, and for displaying the created abnormality degree heat map on the display device 170. In regard to the color to be assigned in correspondence with the abnormality degree, a lookup table (LUT) in which a value of the abnormality degree and a color are associated with each other may be determined in advance, or an LUT may be created in accordance with a value range of the abnormality degree obtained through analysis in Step S330. In another case, the user may determine, through the input device 160, a lower limit value and an upper limit value of the abnormality degree to be displayed, and the LUT and the abnormality degree heat map may be updated in accordance with the lower limit value and the upper limit value.

The display control unit 140 is preferred to be configured to be able to perform control for simultaneously displaying the result of the analysis performed by the analysis unit 130 and the information regarding the thickness of the retinal layer. That is, in this embodiment, the display control unit 140 is preferred to perform control for displaying the created abnormality degree heat map side by side with the retinal layer thickness map used as the input to the trained model, or for displaying the created abnormality degree heat map in such a manner as to be superimposed on the retinal layer thickness map.

The display control unit 140 may also perform control so that an optic papilla region or other such region in which the thickness of the retinal layer cannot be measured is displayed by performing mask processing on the retinal layer thickness map and the abnormality degree heat map.

Further, the display control unit 140 may perform control so that a threshold value for determining the abnormality degree of a pixel to be considered to be abnormal is determined for the abnormality degree map and a region having an abnormality degree equal to or larger than the threshold value is highlight-displayed. For example, the display control unit 140 may perform control so that a contour line surrounding the region having an abnormality degree equal to or larger than the threshold value is displayed on the abnormality degree heat map. A numerical value determined by the training of the trained model may be used as the threshold value, or the user may designate the threshold value through the input device 160.

The display control unit 140 may also perform control so as to create and display a retinal layer thickness heat map corresponding to the retinal layer thickness map.

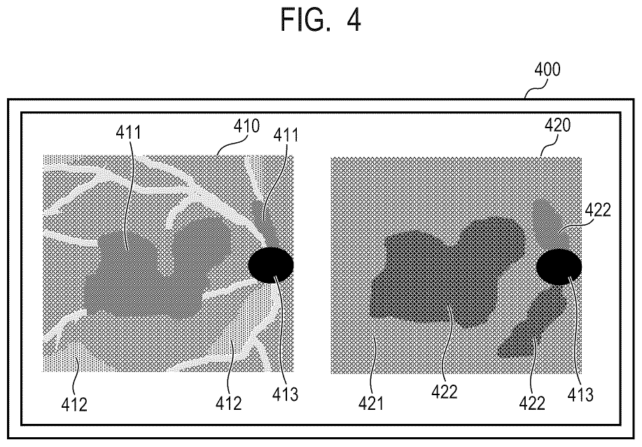

In FIG. 4, an example in which a retinal layer thickness heat map 410 and an abnormality degree heat map 420 are displayed side by side on a display 400 serving as the display device 170 is illustrated. The retinal layer thickness heat map 410 is an image in which a degree of the measured thickness is indicated by black and white shades. For example, a region 411 indicates a region having a large thickness, and a region 412 indicates a region having a small thickness. Meanwhile, the abnormality degree heat map 420 is an image in which a magnitude of the abnormality degree is indicated by black and white shades. For example, a region 421 indicates a region having a low abnormality degree, and a region 422 indicates a region having a high abnormality degree. A region 413 indicates a region subjected to the mask processing for filling the optic papilla portion with black pixels.

In regard to an LUT serving as a reference for a color to be assigned to the thickness of the retinal layer, an LUT in which a value of the thickness of the retinal layer and a color are associated with each other may be determined in advance, or an LUT may be created in accordance with a value range of the thickness of the retinal layer used as the input. In another case, the user may determine, through the input device 160, a lower limit value and an upper limit value of the abnormality degree to be displayed, and the LUT and the retinal layer thickness heat map may be updated in accordance with the lower limit value and the upper limit value. The display control unit 140 may also be configured to be able to switch a display method for the information regarding the thickness of the retinal layer based on the information regarding the elongation state. Specifically, for example, the display control unit 140 may be configured to be able to perform the display by switching the LUT in accordance with the information regarding the elongation state of the eyeball.

The switching of the LUT in accordance with the information regarding the elongation state of the eyeball is useful in a case in which, for example, a thickness value of the retinal layer thickness map is generally smaller than a standard thickness due to myopia. Specifically, an LUT for a myopic eye and an LUT for a standard eye are prepared, and when the scalar value of the ocular axial length is equal to or larger than a certain value, the LUT for a myopic eye is used. Thus, even in the retinal layer thickness map in which the subject exhibits a value generally lower than the standard due to myopia or the like, the user can observe a difference in thickness within the retinal layer thickness with colors equivalent to those of the LUT corresponding to the standard thickness.

Further, when OCT images of the subject can be acquired from the data server 230, the display control unit 140 may be configured as follows. That is, the display control unit 140 may be configured to be able to display, when the user designates a freely-selected position in the abnormality degree heat map through the input device 160, a slice image corresponding to a designated position among the OCT images. This allows the user to quickly view a state of the retinal layer in a region having a high abnormality degree.

An example of displaying the abnormality degree map in Step S340 has been described in this embodiment, but the function of the display control unit 140 is not essential in the information processing apparatus 100, and, for example, the display of the abnormality degree map in this embodiment is not required to be performed. That is, the information processing apparatus 100 may be configured to end the process by storing the abnormality degree map without performing the processing step of Step S340.

With the information processing apparatus 100 according to this embodiment, it is possible to efficiently and appropriately analyze an abnormality in the thickness of the retinal layer through use of the trained model that uses, as input, the information regarding the elongation state of the eyeball and the data including the information regarding the thickness of the retinal layer.

A method of generating different training data sets and trained models in accordance with the information on the ocular axial length is also conceivable. However, when different training data sets are used in accordance with information on the ocular axial length, an amount of the training data in each model is expected to adversely become smaller. Meanwhile, for the abnormality detection model in this embodiment, pieces of information on the ocular axial length included in the training data may be different from each other, and the training can be performed through use of a large number of pieces of training data.

### Modification Example 1 of First Embodiment: Variation of Information Regarding Elongation State of Eyeball

In the first embodiment, an example in which the information on the ocular axial length is acquired as the information regarding the elongation state of the eyeball in the processing performed by the elongation information acquisition unit 110 in Step S310 has been described. However, the information to be acquired by the elongation information acquisition unit 110 may be any scalar value that indicates the information regarding the elongation state of the eyeball, and is not limited to the information on the ocular axial length.

The information regarding the elongation state of the eyeball can include, for example, one or a combination of two or more of scalar values that each represent any one of an ocular axial length, a visual acuity, eyeball refraction data, or a shape of the eyeball. The ocular axial length can be measured by, for example, an ocular axial length measuring apparatus or an OCT apparatus. The visual acuity can be measured, for example, by a visual acuity test. The eyeball refraction data may include a refractive power measured by an objective refraction test (refractometer) and a radius of curvature of a cornea. Further, each of the above-mentioned scalar values may be calculated by acquiring the image of an eyeball and performing image analysis thereon. For example, the scalar value of the ocular axial length is calculated based on an image of an eyeball photographed by an MRI or CT apparatus.

In this modification example, an example in which information on the visual acuity is used in place of the information on the ocular axial length and an example in which both the information on the ocular axial length and the information on the visual acuity are used are described.

In a case of using the information on the visual acuity in place of the information on the ocular axial length, the information on the visual acuity, in place of the information on the ocular axial length, is acquired in the processing step of Step S310.

After that, in Step S330, the information on the visual acuity, in place of the information on the ocular axial length, is input to a machine learning model. Then, the information on the visual acuity is used in place of the information on the ocular axial length to generate a trained model and calculate the abnormality degree map.

Meanwhile, in a case of using both the information on the ocular axial length and the information on the visual acuity, in the processing step of Step S310, the information on the ocular axial length and the information on the visual acuity are acquired.

When a plurality of types of information regarding the elongation state of the eyeball are acquired in Step S310, output results obtained by a plurality of trained models corresponding to the types of respective pieces of information are acquired in Step S330.

An operation to be performed when a plurality of types of information regarding the elongation state of the eyeball are acquired in Step S310 is not limited to the acquisition of the output results obtained by the plurality of trained models. For example, it is also possible to use, as input, two or more pieces of information regarding the elongation state of the eyeball and the data including the information regarding the thickness of the retinal layer to train the trained model and calculate the abnormality degree map. In that case, in the training of the trained model and the calculation of the abnormality degree map, which have been mentioned in the description of Step S330, respective scalar values indicating the pieces of information regarding the elongation state of the eyeball are only required to be provided to the tensors.

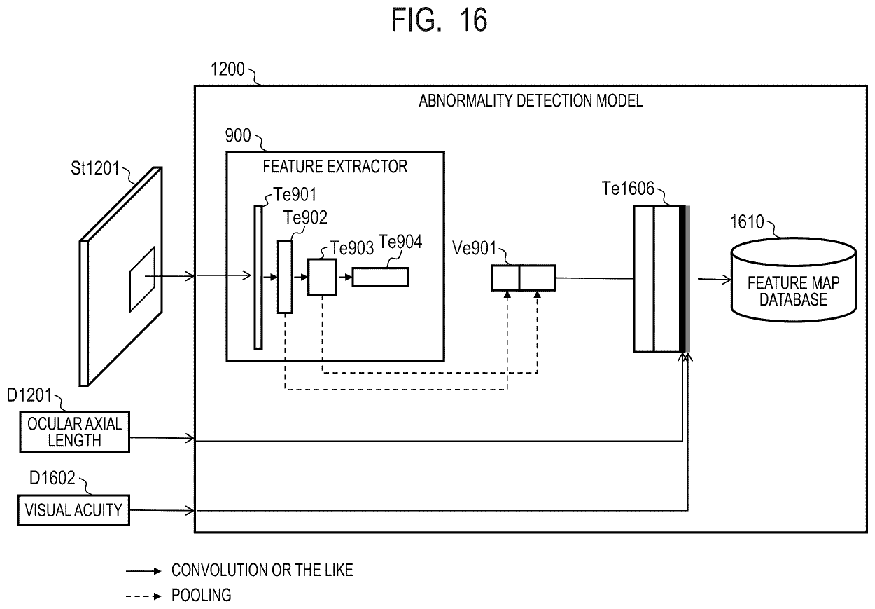

FIG. 16 is an example of further inputting a scalar value D1602 indicating a visual acuity in the example illustrated in FIG. 12. In FIG. 12, it has been described that a tensor Te1606 is generated by extending a tensor having a shape of “N×H×W” to a shape of “(N+1)×H×W” in terms of the number of channels, and the value of the extended tensor region is filled in with the scalar value D1201. In contrast, in the example of FIG. 16, processing for extending the tensor to a shape of “(N+2)×H×W” and for filling in a first extended channel with the scalar value D1201 and a second extended channel with the scalar value D1602 is added.

In this manner, even a case in which a plurality of types of information regarding the elongation state of the eyeball are acquired can be handled by extending the channel of the tensor in accordance with the number of pieces of information regarding the elongation state of the eyeball and embedding the scalar value in each channel.

In a case of using, as input, a plurality of types of information regarding the elongation state of the eyeball, the scalar values indicating the ocular axial length, the visual acuity, the refractive power, and the like are preferred to be numerical values subjected to standardization or min-max normalization so as to be able to be handled on the same scale. An average value or a standard deviation to be used for calculation of the standardization or a minimum value and a maximum value to be used for the min-max normalization may be calculated from the information regarding the elongation state of the eyeball stored on the data server 230, or may be able to be designated by the user.

Here, the elongation state of a standard eyeball may also change depending on an age group or a gender of the subject. Thus, standardization or normalization may be performed in accordance with information such as the age group or the gender of the subject. In that case, for example, the information on the ocular axial length on the data server 230 is grouped into groups of males and females, and an average value and a standard deviation for each group are calculated. Then, when the information on the ocular axial length of a male is input, the input information on the ocular axial length is standardized through use of the average value and the standard deviation that have been calculated for the male group.

With the information processing apparatus according to this modification example, when information other than that on the ocular axial length is used as the information regarding the elongation state of the eyeball, it is possible to efficiently and appropriately analyze an abnormality in the thickness of the retinal layer.

### Modification Example 2 of First Embodiment: Variation of Data Including Information Regarding Thickness of Retinal Layer

In the first embodiment, an example in which the retinal layer thickness map is used as the data including the information regarding the thickness of the retinal layer in the processing performed by the data acquisition unit 120 in Step S320 has been described, but the present invention is not limited thereto, and the data to be acquired may be any measurement data from which the retinal layer thickness can be measured.

The data including the information regarding the thickness of the retinal layer can include, for example, at least any one selected from the group consisting of an OCT image, a map image (retinal layer thickness map) in which information indicating the thickness of the retinal layer is projected onto a plane along a fundus of an eye, retinal layer segmentation data, an image of an eyeball photographed by an MRI apparatus, and an image of an eyeball photographed by a CT apparatus.

The retinal layer thickness map as used herein refers to, for example, the retinal layer thickness map obtained by measuring the thickness from the inner plexiform layer to the internal limiting membrane. In the following description of this modification example, the retinal layer thickness map obtained by measuring the thickness from the Bruch's membrane to the internal limiting membrane, which has been used in the first embodiment, is referred to as “retinal layer thickness map A,” and the retinal layer thickness map obtained by measuring the thickness from the inner plexiform layer to the internal limiting membrane is referred to as “retinal layer thickness map B.”

In this modification example, an example in which the retinal layer thickness map B is used in place of the retinal layer thickness map A and an example in which both the retinal layer thickness map A and the retinal layer thickness map B are used are described.

In a case of using the retinal layer thickness map B in place of the retinal layer thickness map A, the retinal layer thickness map B, in place of the retinal layer thickness map A, is acquired in the processing step of Step S320.

After that, in Step S330, the retinal layer thickness map B, in place of the retinal layer thickness map A, is input to generate a trained model and calculate the abnormality degree map of the retinal layer thickness map B.

In a case of using both the retinal layer thickness map A and the retinal layer thickness map B, in the processing step of Step S320, the retinal layer thickness map A and the retinal layer thickness map B are acquired.

In Step S330, output results obtained by a plurality of trained models corresponding to respective pieces of data including the information regarding the thickness of the retinal layer are acquired. In this case, it is also possible to use, as input, two or more pieces of data including the information regarding the thickness of the retinal layer to train the trained model and calculate the abnormality degree map.

For example, an operation in which, as the feature vector is extracted from the retinal layer thickness map A through use of the feature extractor in the abnormality detection model illustrated in FIG. 12, a feature vector obtained by extracting a feature by a feature extractor is extracted from the retinal layer thickness map B and those feature vectors are connected is also added. Thus, a feature map taking into consideration the features of both input images can be calculated. Even in a case of using volume data such as an OCT image, a publicly known network model corresponding to the volume data is used as a base to generate a feature extractor, to thereby be able to use, as input, the OCT image and the elongation state of the eyeball.

With the information processing apparatus according to this modification example, when measurement data other than the retinal layer thickness map is used as the data including the information regarding the thickness of the retinal layer, it is possible to efficiently and appropriately analyze an abnormality in the thickness of the retinal layer.

### Modification Example 3 of First Embodiment: Variation 1 of Trained Model

In the first embodiment, an example of using the trained model for outputting the abnormality degree map in the processing performed by the analysis unit 130 in Step S330 has been described, but the embodiment of the present invention is not limited thereto. The trained model to be used may be any model that outputs information for the user to analyze an abnormality in the measurement data of the retinal layer thickness. For example, a model that uses, as input, the retinal layer thickness map and the information on the ocular axial length to output the true or false value indicating the presence or absence of a predetermined disease or the scalar value indicating the possibility of having a predetermined disease may be used. In this case, examples of the disease include at least any one selected from the group consisting of glaucoma, posterior staphyloma, retinal detachment, diabetic retinopathy, retinal choroidal atrophy, macular hemorrhage, myopic traction maculopathy, and myopic choroidal neovascularization.

In the first embodiment, an example of training the network model that receives images as input to perform class classification has been described with reference to FIG. 10. In this modification example, an example of modifying the above-mentioned example to generate a class classification model that receives, as input, the retinal layer thickness map and the information on the ocular axial length to output an analysis result of a disease is described. In this modification example, a class classification model that performs classification into three classes of glaucoma, posterior staphyloma, and absence of a disease is described as an example.

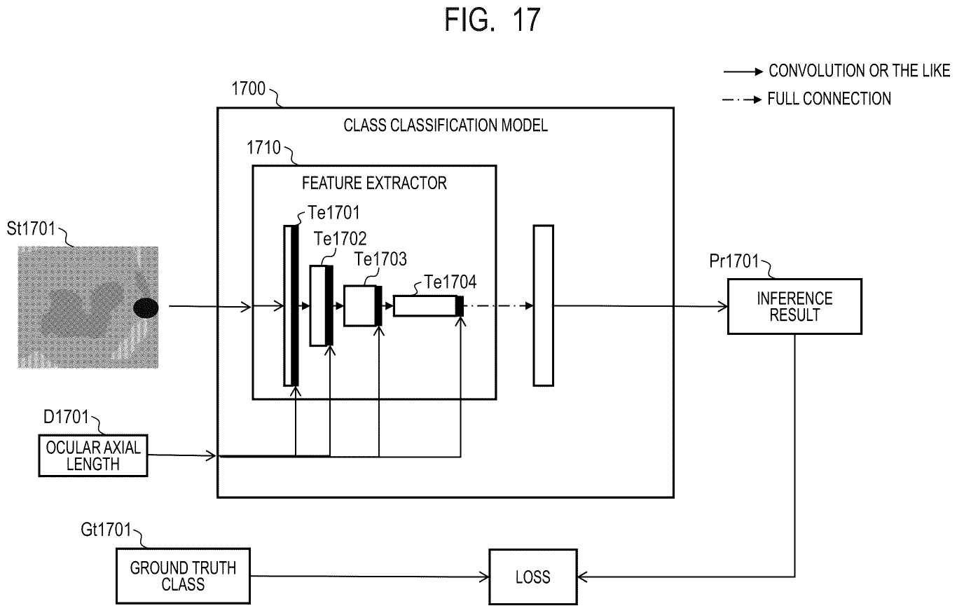

FIG. 17 is a diagram for illustrating a configuration of and a training method for a class classification model in this modification example. In this modification example, a scalar value D1701 indicating the ocular axial length is provided to a class classification model 1700. Specifically, the scalar value D1701 indicating the ocular axial length is provided to at least one tensor spatial axis among the number of channels, the height, and the width of at least one tensor of tensors generated in intermediate layers of a feature extractor 1710 responsible for feature extraction of images. A method of providing the scalar value is the same as the method described with reference to FIG. 12. In the example illustrated in FIG. 17, the scalar value D1701 indicating the ocular axial length is provided to all tensors of tensors Te1701 to Te1704. The method of providing the scalar value D1701 indicating the ocular axial length is not limited thereto, and there may be, for example, a form in which the scalar value is provided to the tensors Te1702 and Te1703 or a form in which the scalar value is provided to only the tensor Te1703.

The class classification model 1700 in this modification example receives, as input, a retinal layer thickness map St1701 and the scalar value D1701 indicating the ocular axial length to output an inference result Pr1701 through, as described above, the provision of the information on the ocular axial length to the tensors and the operations such as convolutions. In this case, the inference result Pr1701 is a vector having, as each element, a likelihood that the input may belong to a class, and in a case of using the three classes of glaucoma, posterior staphyloma, and absence of a disease, is a vector having, as elements, for example, numerical values 0.1, 0.1, and 0.8 corresponding to the three classes, respectively. The class classification model 1700 can be trained based on an error (loss) between a ground truth class Gt1701 in the training data and the inference result Pr1701 in the same manner as such a general training method of the class classification as described in the first embodiment.

The example of generating a class classification model that receives, as input, the retinal layer thickness map and the information on the ocular axial length to output the analysis result of a disease has been described above.

An example of using a classification model for the three classes of glaucoma, posterior staphyloma, and absence of a disease has been described, but the present invention is not limited thereto. For example, a model for performing classification into two classes of presence or absence of a disease or a model for performing classification into two classes of presence or absence of a specific disease may be used, or a plurality of classification models may be used in combination. As another example, there may be a form of employing a model for performing classification into presence or absence of a disease and, when data exhibits the presence of a disease, performing classification into two classes of glaucoma and posterior staphyloma.

In a case of outputting the true or false value or the scalar value, in Step S340, the display control unit 140 displays, on the display device 170, each disease targeted by the trained model and the true or false value or the scalar value, which relates to the output, or both thereof. In a case of displaying the scalar value, a numerical value corresponding to the targeted disease may be acquired from an inference result of the class classification model. Meanwhile, in a case of outputting the true or false value, the true or false value may be output as 1 when the acquired scalar value is equal to or larger than a threshold value, and output as 0 when the acquired scalar value is less than the threshold value. The threshold value may be set to, for example, 0.5.

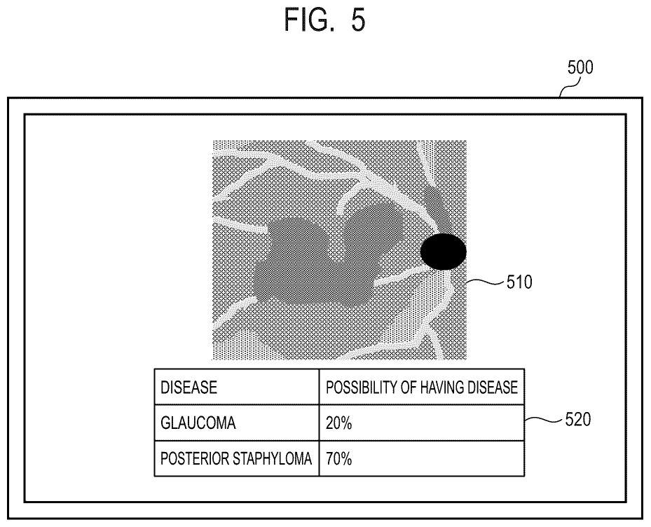

The user may be allowed to designate, through the input device 160, a disease to which the class classification model to be selected relates, whether to output the true or false value or the scalar value, or the like. In another case, the display control unit 140 may be configured to be able to list results (scalar values or true or false values indicating the presence or absence of the respective diseases) obtained when a plurality of trained models relating to respective diseases are used and to display the results side by side with the retinal layer thickness map. FIG. 5 is an example of displaying, on a display 500 serving as the display device 170, a retinal layer thickness heat map image 510 and a table 520 in which the possibility of having glaucoma and the possibility of having posterior staphyloma are listed.

The display control unit 140 may also be configured to be able to display a region-of-interest map image representing which region of input image data has been focused on by the class classification model that receives an image as input to output the true or false value or the scalar value. The region-of-interest map images can be output through use of a method such as, for example, GradCAM or SmoothGrad.

With the information processing apparatus according to this modification example, the user can easily analyze an abnormality in the retinal layer thickness data.

### Modification Example 4 of First Embodiment: Variation 2 of Trained Model

In Modification Example 3 of the first embodiment, an example in which the model that outputs the true or false value indicating the presence or absence of a disease or the scalar value indicating the possibility of having a disease is used as the trained model for outputting the abnormality degree map has been described, but the embodiment of the present invention is not limited thereto. The trained model to be used may be, for example, a trained model that uses, as input, the retinal layer thickness map and the information on the ocular axial length to output data (hereinafter also referred to as “estimated normal retinal thickness data”) indicating the thickness of the retinal layer expected to be obtained when the thickness of the retinal layer is normal. As such a trained model, for example, a trained model based on the AutoEncoder may be used.

In a case of using the AutoEncoder, the network model is required to be modified, and, for example, it is possible to modify and use the AutoEncoder as described in the first embodiment with reference to FIG. 13.

In a case of outputting the estimated normal retinal thickness data, as in the example of the abnormality degree map illustrated in FIG. 4, it is preferred to display the estimated normal retinal thickness data and the retinal layer thickness map side by side, or to display the estimated normal retinal thickness data so as to be superimposed on the retinal layer thickness map.

With the information processing apparatus according to this modification example, the user can easily grasp data on the thickness of the retinal layer expected to be obtained when the thickness of the retinal layer is normal with respect to data on the thickness of the retinal layer relating to the input.

Further, the display control unit 140 may be configured to be able to display difference data obtained by taking a difference between the data on the thickness of the retinal layer relating to the input and the estimated normal retinal thickness data together. This allows the user to compare the data on the thickness of the retinal layer relating to the input and the estimated normal retinal thickness data to easily grasp where an abnormality has occurred.

In this modification example, the case of using the AutoEncoder has been described as an example, but the present invention is not limited thereto, and a trained model of another image generation system such as GAN may be modified and used.

As described above, in this modification example, an example of using the trained model that outputs the estimated normal retinal thickness data has been described. As described in the first embodiment and Modification Examples 3 and 4 of the first embodiment, a variety of trained models can be used in the present invention. That is, the result obtained through the analysis by the analysis unit 130 can include at least any one selected from the group consisting of the map image indicating the degree of abnormality in the thickness of the retinal layer, the true or false value indicating the presence or absence of a disease, the scalar value indicating the possibility of having a disease, and the thickness data of the retinal layer expected to be obtained when the thickness of the retinal layer is normal.

### Second Embodiment

In the first embodiment, an example in which information for analyzing an abnormality in the thickness of the retinal layer is output and displayed through use of the trained model that uses, as input, the information regarding the elongation state of the eyeball and the data including the information regarding the thickness of the retinal layer has been described. In this embodiment, an example of selecting at least one trained model from a plurality of trained models based on the information regarding the elongation state of the eyeball is described.

A configuration of an information processing system including an information processing apparatus according to a second embodiment is the same as the configuration of the information processing system 10 including the information processing apparatus 100 according to the first embodiment illustrated in FIG. 1 and FIG. 2, and hence description thereof is omitted.

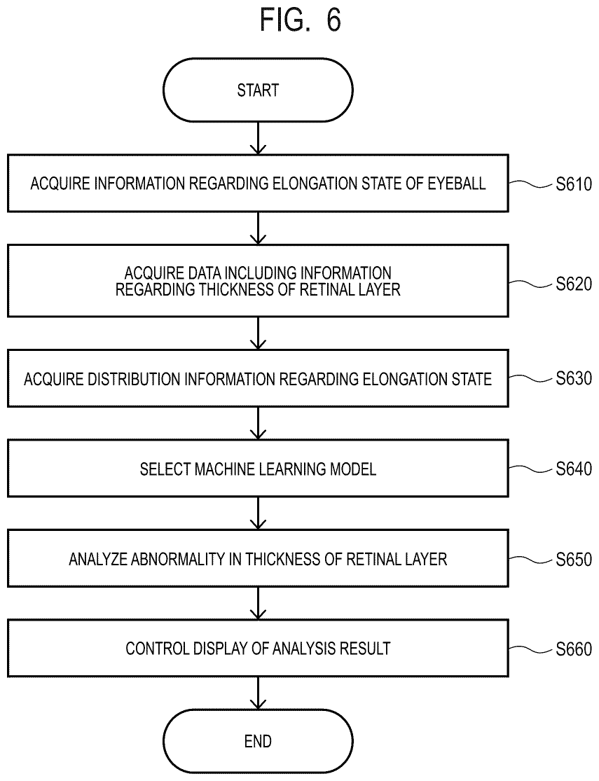

An example of processing of the information processing apparatus 100 according to the second embodiment is described with reference to FIG. 6. FIG. 6 is a flow chart for illustrating an example of a processing procedure in an information processing method to be performed by the information processing apparatus 100 according to the second embodiment. In this embodiment, the following example is described. That is, in the same manner as in the first embodiment, the information on the ocular axial length is acquired as the information regarding the elongation state of the eyeball, and the retinal layer thickness map is also acquired as the data including the information regarding the thickness of the retinal layer. Then, in the same manner as in the first embodiment, those are input to the trained model that outputs the abnormality degree map regarding the thickness of the retinal layer, and the output abnormality degree map is displayed.

An elongation information acquisition step of Step S610 and a data acquisition step of Step S620 are the same as Step S310 and S320 in the first embodiment described with reference to FIG. 3, respectively, and hence description thereof is omitted.

### (S630: Distribution Information Acquisition Step)

In this embodiment, the analysis unit 130 includes a plurality of trained models, and is configured to be able to select and use at least one trained model from the plurality of trained models based on the elongation state of the eyeball to be analyzed. In this case, the information used for the training by the plurality of trained models includes the training information regarding the elongation state of the eyeball.

In this embodiment, the analysis unit 130 is also configured to acquire, from each of the plurality of trained models, distribution information regarding the elongation state included in the training information regarding the elongation state of the eyeball, and to select at least one trained model based on the distribution information and the information regarding the elongation state of the eyeball to be analyzed.

Specifically, first, in a distribution information acquisition step of Step S630, the analysis unit 130 acquires information regarding a distribution of ocular axial lengths of subjects used for training of the trained models.

On the data server 230, pieces of information on the ocular axial lengths of subjects used for the training are stored in association with each trained model, and the information regarding the distribution of the ocular axial lengths of the respective trained models can be acquired by referring to those pieces of information.

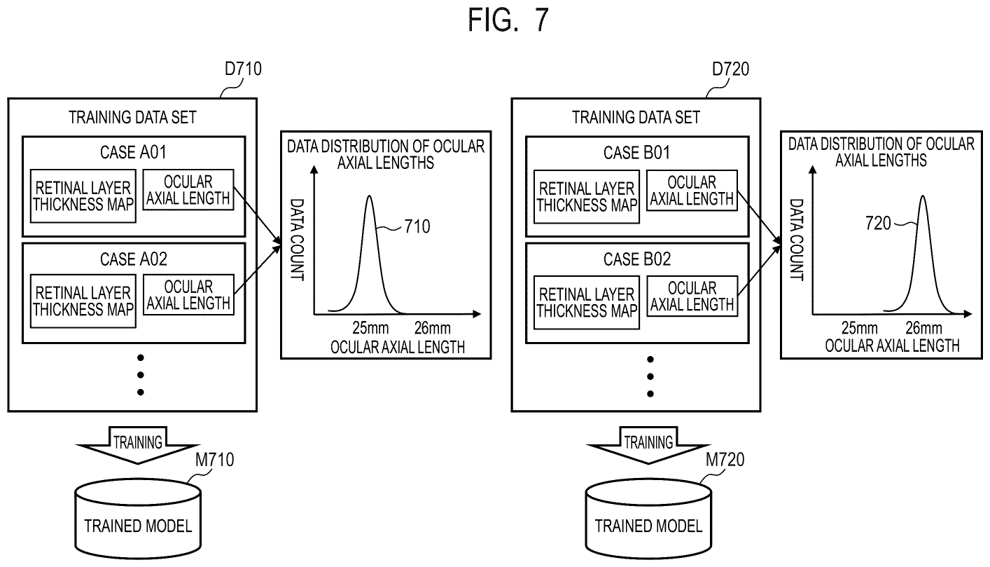

FIG. 7 is a diagram for illustrating an example of pieces of information regarding mutually different distributions of ocular axial lengths included in two trained models M710 and M720.

In this case, the trained models M710 and M720 are trained models trained with data sets D710 and D720 including different distributions of the ocular axial lengths, respectively. The trained models are assumed to have been generated in advance by the method of generating a trained model described in the first embodiment and the modification examples thereof.

In FIG. 7, a distribution 710 is the information regarding the distribution of the ocular axial lengths included in the trained model M710, and is such a distribution as to have a mode value of 25 mm. Further, the distribution 720 is the information regarding the distribution of the ocular axial lengths included in the trained model M720, and is such a distribution as to have a mode value of 26 mm. In FIG. 7, an example of a case of using two trained models is illustrated, but three or more trained models may be used.

When the data server 230 holds information regarding the distribution such as the above-mentioned mode value, the analysis unit 130 may be configured to acquire the information regarding the distribution such as the mode value from the data server 230.

### (S640: Model Selection Step)

In a model selection step of Step S640, the analysis unit 130 selects a trained model based on the information on the ocular axial length, which has been acquired in Step S610, and the information regarding the distribution of the ocular axial lengths included in the trained model, which has been acquired in Step S630.

Specifically, the information on the ocular axial length, which has been acquired in Step S610, and the mode value of the information regarding the distribution of the ocular axial lengths in each the trained model are compared to each other, and a trained model including the information regarding the distribution of the ocular axial lengths having the mode value that is closest to the information on the ocular axial length, which has been acquired in Step S610, is selected.

For example, when the information on the ocular axial length, which has been acquired in Step S610, is 25 mm, the trained model M710 is selected in the example illustrated in FIG. 7.

A method of selecting the trained model is not limited to a method of comparing the information on the ocular axial length and the mode value of the information regarding the distribution of the ocular axial lengths to each other. For example, the trained model that is closest to the information on the ocular axial length used as the input may be selected in comparison to an average value or a median value, in place of the mode value, of the information regarding the distribution of the ocular axial lengths.

As another configuration, a threshold value for selecting the trained model may be calculated in advance based on the pieces of information regarding the distributions of the ocular axial lengths and held on the data server 230. For example, when the trained model includes the pieces of information regarding the distributions illustrated in FIG. 7, 25.5 mm, which is an average of the mode values of the respective distributions, is held as the threshold value. In the selection of the trained model, the threshold value is compared to the information on the ocular axial length, which has been acquired in Step S610, and when the value relating to the information on the ocular axial length, which has been acquired in Step S610, is smaller than the threshold value, the model M710 is selected, and when the value is equal to or larger than the threshold value, the model M720 is selected.

An analysis step of Step S650 and a display control step of Step S660 are the same as Step S330 and Step S340 in the first embodiment described with reference to FIG. 3, respectively, and hence description thereof is omitted.

As described above, according to this embodiment, when there are a plurality of trained models trained with the training data having different ranges and distributions of elongation states of the eyeball, an appropriate trained model can be selected.

### Modification Example 1 of Second Embodiment: Variation of Information Regarding Elongation State of Eyeball

In the second embodiment, the example in which the information on the ocular axial length is acquired as the information regarding the elongation state of the eyeball in the processing performed by the elongation information acquisition unit 110 in Step S610 has been described, but the information to be acquired is not limited to the information on the ocular axial length.

For example, in the same manner as in Modification Example 1 of the first embodiment, information on the visual acuity measured by the visual acuity test, the refractive power measured by an objective refraction test (refractometer), or the like may be acquired as the information regarding the elongation state of the eyeball.

Specifically, in a case of using the information on the visual acuity in place of the information on the ocular axial length, the information on the visual acuity and information regarding a distribution of visual acuities may be used in place of the information on the ocular axial length and the information regarding the distribution of the ocular axial lengths used in Step S610, Step S620, and Step S630 in the second embodiment.

A plurality of types of information regarding the elongation state of the eyeball can also be used. For example, the information on the ocular axial length and the information on the visual acuity can be used together.

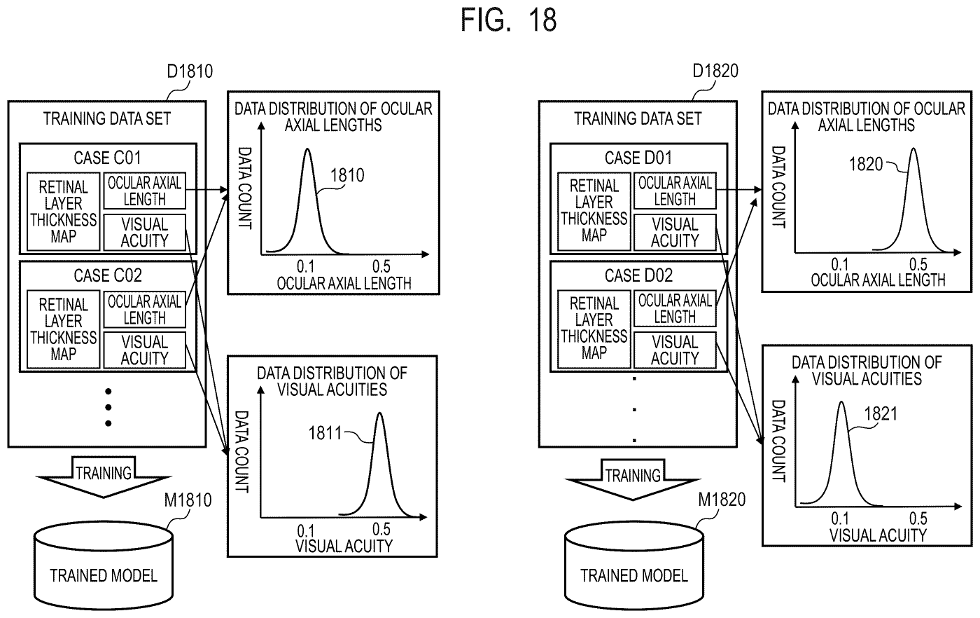

FIG. 18 is a diagram for illustrating an example of a case in which two trained models M1810 and M1820 have pieces of information regarding mutually different distributions of ocular axial lengths and pieces of information regarding mutually different distributions of visual acuities.

In this case, the trained models M1810 and M1820 are trained models trained with data sets D1810 and D1820 including pieces of information regarding mutually different distributions of the ocular axial lengths or the visual acuities, respectively. The trained models are assumed to have been generated in advance by the method of generating a trained model described in the first embodiment and the modification examples thereof.

In FIG. 18, a distribution 1810 and a distribution 1811 are the information regarding the distribution of the ocular axial lengths and the information regarding the distribution of the visual acuities that are included in the trained model M1810, respectively. A distribution 1820 and a distribution 1821 are the information regarding the distribution of the ocular axial lengths and the information regarding the distribution of the visual acuities that are included in the trained model M1820, respectively.

As described in Modification Example 1 of the first embodiment, in a case of using, as input, a plurality of types of information regarding the elongation state of the eyeball, the scalar values indicating the ocular axial length, the visual acuity, the refractive power, and the like are preferred to be numerical values subjected to standardization or min-max normalization. This enables those scalar values to be handled on the same scale. In a case of performing normalization, the same normalization is performed on the input data. FIG. 18 is an illustration of an example of data distribution of the ocular axial lengths and data distribution of the visual acuities after the normalization.

In a case of using a plurality of types of information regarding the elongation state of the eyeball, in Step S640, the analysis unit 130 calculates, for each type of the information regarding the elongation state of the eyeball, a difference between the mode value of each distribution and the input data. Then, an average value of the calculated differences from the mode values is calculated for each of the plurality of trained models, and a trained model having a small average value is selected. For example, when the ocular axial length after the normalization of the input data is 0.1 and the visual acuity after the normalization is 0.5 with respect to the trained model illustrated in FIG. 18, the trained model M1810 is selected.

Here, a case in which the types of information regarding the elongation state of the eyeball acquired as the input data differ from the types of the information regarding the elongation state of the eyeball used for the training of the trained model is also assumed. Specific examples thereof include a case in which the information on the ocular axial length and the information on the visual acuity are used as the input data, while there are four trained models M710, M720, M1810, and M1820 illustrated in FIG. 7 and FIG. 18. The trained models M710 and M720 are each the trained model that uses, as input, the retinal layer thickness map and the information on the ocular axial length to output the abnormality degree map. Meanwhile, the trained models M1810 and M1820 are each the trained model that uses, as input, the retinal layer thickness map, the information on the ocular axial length, and the information on the visual acuity to output the abnormality degree map.

In such a case, the trained model may be selected based on any type of information regarding the elongation state of the eyeball. For example, when the information on the ocular axial length and the information on the visual acuity are acquired as the input data, the trained model is selected based on the information on the ocular axial length. A method of selecting the trained model based on the information on the ocular axial length is the same as the method described in the second embodiment.

In the selection of the trained model, which type of information regarding the elongation state is to be used may be determined in advance, or may be a form that can be designated by the user through the input device 160.

When any type of information regarding the elongation state of the eyeball to be used for the selection of the trained model is not included in the information regarding the elongation state of the eyeball in the training data for the trained model, the corresponding trained model may be excluded from options. For example, in a case of selecting the model from the four trained models illustrated in FIG. 7 and FIG. 18 through use of the information on the ocular axial length and the information on the visual acuity, the trained models M710 and M720 do not include the information regarding the distribution of the visual acuities to be referred to, and thus are excluded from the options.

With the information processing apparatus according to this modification example, even when information other than the information on the ocular axial length is available as the information regarding the elongation state of the eyeball, an appropriate trained model can be selected from a plurality of trained models.

### Modification Example 2 of Second Embodiment: Selection of Plurality of Trained Models

In the second embodiment, the example of selecting one trained model from a plurality of trained models in the processing performed by the analysis unit 130 in Step S630 has been described, but two or more trained models may be selected.

For example, all the trained models in which a difference between the information on the ocular axial length, which has been acquired in Step S610, and the mode value of the information regarding the distribution of the ocular axial lengths in each trained model is equal to or smaller than a threshold value are selected.

When a plurality of trained models are selected, the display control unit 140 may be configured to display output results obtained by the respective trained models in Step S660, or may be configured to calculate and display an average of the output.

With the information processing apparatus according to this modification example, even when there are a plurality of trained models having similar ranges and distributions of information regarding elongation states of eyeballs of subjects used for the training, an appropriate trained model can be selected.

### Third Embodiment

In the first embodiment, an example in which information for analyzing an abnormality in the thickness of the retinal layer is output and displayed through use of the trained model that uses, as input, the information regarding the elongation state of the eyeball and the data including the information regarding the thickness of the retinal layer has been described. In this embodiment, an example of correcting the output from the trained model based on the information regarding the elongation state of the eyeball and displaying the corrected output is described.

A configuration of an information processing system including an information processing apparatus according to a third embodiment is the same as the configuration of the information processing system 10 including the information processing apparatus 100 according to the first embodiment illustrated in FIG. 1 and FIG. 2, and hence description thereof is omitted.

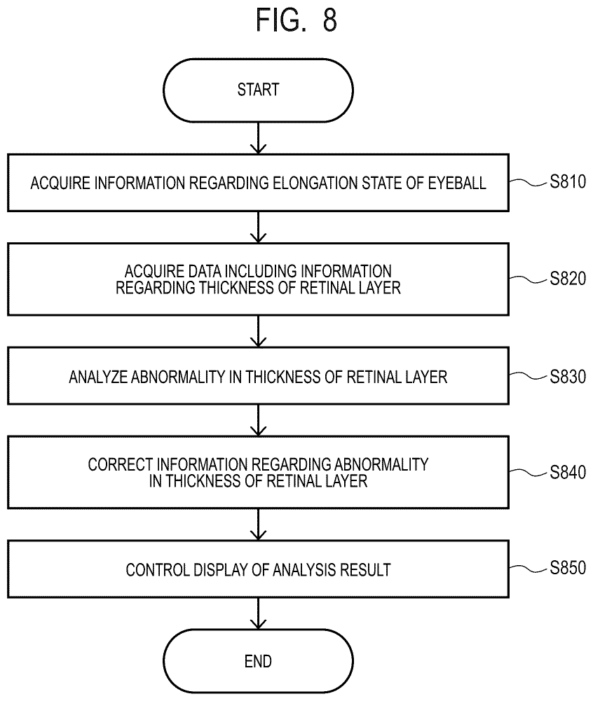

An example of processing of the information processing apparatus 100 according to the third embodiment is described with reference to FIG. 8. FIG. 8 is a flow chart for illustrating an example of a processing procedure in an information processing method to be performed by the information processing apparatus 100 according to the third embodiment. In this embodiment, the following example is described. That is, in the same manner as in the first embodiment, the information on the ocular axial length is acquired as the information regarding the elongation state of the eyeball, and the retinal layer thickness map is acquired as the data including the information regarding the thickness of the retinal layer. Then, in the same manner as in the first embodiment, those are input to the trained model that outputs the abnormality degree map on the thickness of the retinal layer, and the abnormality degree map output by the trained model is displayed.

An elongation information acquisition step of Step S810, a data acquisition step of Step S820 and a display control step of Step S850 are the same as Step S310, Step S320, and Step S340 in the first embodiment described with reference to FIG. 3, respectively, and hence description thereof is omitted.

### (S830: Analysis Step)

In Step S830, the analysis unit 130 inputs the retinal layer thickness map, which has been acquired in Step S820, to the trained model, to output the abnormality degree map on the thickness of the retinal layer.

In this embodiment, an example in which the retinal layer thickness map is acquired as the data including the information regarding the thickness of the retinal layer is described, while in accordance with the type of the acquired data including the information regarding the thickness of the retinal layer, the analysis unit 130 selects the trained model that uses the acquired data as input from the data server 230.

As the trained model for outputting the abnormality degree map, the publicly known abnormality detection model or segmentation model described in the first embodiment can be used.

### (S840: Correction Step)

In this embodiment, the analysis unit 130 is configured to correct the information regarding the abnormality in the thickness of the retinal layer, which has been output from the trained model in Step S830, based on the information regarding the elongation state, which has been acquired in Step S810.

That is, in Step S840, the analysis unit 130 corrects the abnormality degree map, which has been acquired in Step S830, based on the information on the ocular axial length, which has been acquired in Step S810.

Specifically, a weight value “w” is calculated based on the information on the ocular axial length, and the abnormality degree in each pixel of the abnormality degree map is multiplied by the weight value “w” to correct the abnormality degree map. The weight value “w” is a value calculated by Expression (1).

$$w = a \times ( 1 - v ) \qquad ( 1 )$$

In Expression (1), a value “v” represents the information on the ocular axial length converted into a value ranging from 0.0 to 1.0, and is calculated by standardization or min-max normalization as described in Modification Example 1 of the first embodiment. Further, a value “a” is a value ranging from 0.0 to 1.0 for determining intensity of the correction, and is, for example, 0.5. A numerical value optimized by training may be used as the value “a”, or the user may be allowed to designate the value “a” through the input device 160.

The analysis unit 130 may multiply a threshold value determined by the training of the trained model by the weight value “w” instead of multiplying the abnormality degree map by the weight value “w”. At this time, the display control unit 140 may be configured to be able to perform, subsequently in Step S850, control so as to highlight-display a region having an abnormality degree equal to or larger than the threshold value multiplied by the weight value “w”. In that case, a value calculated by Expression (2) is used as the weight value “w”.

$$w = a \times v \qquad ( 2 )$$

With the information processing apparatus according to this embodiment, the output from the trained model that uses, as input, the data including the information regarding the thickness of the retinal layer is corrected based on the information regarding the elongation state of the eyeball, thereby being able to efficiently and appropriately analyze an abnormality in the thickness of the retinal layer.

In this embodiment, the case of using the trained model for outputting the abnormality degree map in the processing performed by the analysis unit 130 in Step S830 has been described, but the embodiment of the present invention is not limited thereto. For example, a trained model that outputs the scalar value indicating the possibility of having a disease or the data on the thickness of the retinal layer expected to be obtained when the thickness of the retinal layer is normal may be used.

### Modification Example 1 of Third Embodiment: Calculation of Second Abnormality Degree

In the third embodiment, an example in which the analysis unit 130 corrects the abnormality degree map in Step S840 has been described, but the present invention is not limited thereto. That is, the analysis unit 130 may be configured to input the information on the ocular axial length and the abnormality degree map to a second trained model to output and obtain a second abnormality degree, which is a scalar value indicating a degree of abnormality included in the abnormality degree map. In this case, the abnormality degree map to be input to the second trained model can be obtained, for example, as output obtained when the data including the information regarding the thickness of the retinal layer is input to a first trained model in the same manner as in Step S830 in the third embodiment.

The second abnormality degree can be calculated through use of, for example, the second trained model by generating, as the second trained model, a class classification model that receives, as input, the information on the ocular axial length and the abnormality degree map to perform class classification into two classes of “presence of a disease” and “absence of a disease.”

As the class classification model, a model having the configuration illustrated in FIG. 17, which has been described in Modification Example 3 of the first embodiment, can be used. Specifically, the model illustrated in FIG. 17 may be trained by setting the abnormality degree map as the retinal layer thickness map St1701, which serves as the input image, with the two classes of “presence of a disease” and “absence of a disease.”

The abnormality degree map obtained as the output from the first trained model in Step S830 and the information on the ocular axial length, which has been acquired in Step S810, are input to the class classification model serving as the second trained model trained as described above. Then, a numerical value corresponding to “presence of a disease” is acquired from the output inference result as the second abnormality degree.

With the information processing apparatus according to this embodiment, the user can quantitatively grasp, based on the information on the ocular axial length, the degree of abnormality included in the abnormality degree map.

### Modification Example 2 of Third Embodiment: Correction of Input Data

In the third embodiment, the example in which the analysis unit 130 corrects the abnormality degree map in Step S840 has been described, but the present invention is not limited thereto. The analysis unit 130 may correct the retinal layer thickness map based on the information on the ocular axial length in Step S830, and estimate the abnormality degree map from the corrected retinal layer thickness map.

The analysis unit 130 in this modification example corrects the retinal layer thickness map, which has been acquired in Step S320, in accordance with the information on the ocular axial length, and inputs the corrected retinal layer thickness map to the trained model to output the abnormality degree map on the thickness of the retinal layer.

As a specific correction method, the same method as the correction method described in Step S830 in the third embodiment can be employed. That is, the retinal layer thickness map can be corrected by calculating the weight value “w” based on the information on the ocular axial length calculated by Expression (1) and multiplying the value of the thickness in each pixel of the retinal layer thickness map by the weight value “w”.

As the trained model to be used in Step S830, the publicly known abnormality detection model or segmentation model described in the first embodiment can be used in the same manner as in the third embodiment. The trained model is preferred to have been trained through use of the retinal layer thickness map corrected by the same correction method as in this modification example.

With the information processing apparatus according to this embodiment, data of a subject having a retinal layer thickness different from a standard retinal layer thickness due to myopia or the like is input after the retinal layer thickness is corrected to the standard thickness through use of the information on the ocular axial length, thereby enabling the abnormality degree map to be output efficiently.

Any one of the embodiments described above merely indicates an example of implementation for carrying out the present invention, and the technical scope of the present invention is not to be construed in a limiting manner due to those embodiments. That is, the present invention can be carried out in various forms without departing from the technical spirit of the present invention or major features of the present invention. For example, an embodiment in which a configuration of a part of any one of the embodiments is added to another embodiment or an embodiment in which a configuration of a part of any one of the embodiments is substituted by a configuration of a part of another embodiment is also to be understood as an embodiment to which the present invention is applicable.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is possible to provide an information processing apparatus capable of efficiently analyzing an abnormality in the thickness of the retinal layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-203331, filed Nov. 30, 2023, which is hereby incorporated by reference herein in its entirety.

What is claimed is:

1. An information processing apparatus comprising:
an elongation information acquisition unit configured to acquire information regarding an elongation state of an eyeball to be analyzed;
a data acquisition unit configured to acquire data including information regarding a thickness of a retinal layer of the eyeball; and
an analysis unit configured to analyze an abnormality in the thickness of the retinal layer based on the information regarding the elongation state and the data including the information regarding the thickness of the retinal layer,
wherein the analysis unit includes a trained model configured to use, as input, at least the data including the information regarding the thickness of the retinal layer to output information regarding the abnormality in the thickness of the retinal layer.

2. The information processing apparatus according to claim 1, wherein the trained model is configured to further use, as input, the information regarding the elongation state.

3. The information processing apparatus according to claim 1, wherein the information regarding the elongation state includes one or a combination of two or more of scalar values that each represent any one of an ocular axial length, a visual acuity, eyeball refraction data, or a shape of the eyeball.

4. The information processing apparatus according to claim 1, wherein the data including the information regarding the thickness of the retinal layer includes at least any one selected from the group consisting of an optical coherence tomographic image, a map image in which information indicating the thickness of the retinal layer is projected onto a plane along a fundus of an eye, retinal layer segmentation data, an image of the eyeball photographed by a magnetic resonance imaging (MRI) apparatus, and an image of the eyeball photographed by a computed tomography (CT) apparatus.

5. The information processing apparatus according to claim 1, wherein a result obtained through analysis by the analysis unit includes at least any one selected from the group consisting of a map image indicating a degree of abnormality in the thickness of the retinal layer, a true or false value indicating presence or absence of a disease, a scalar value indicating a possibility of having a disease, and thickness data of the retinal layer expected to be obtained when the thickness of the retinal layer is normal.

6. The information processing apparatus according to claim 5, wherein the disease includes at least any one selected from the group consisting of glaucoma, posterior staphyloma, retinal detachment, diabetic retinopathy, retinal choroidal atrophy, macular hemorrhage, myopic traction maculopathy, and myopic choroidal neovascularization.

7. The information processing apparatus according to claim 1, further comprising a display control unit configured to perform control for displaying a result of analysis performed by the analysis unit.

8. The information processing apparatus according to claim 7, wherein the display control unit is configured to perform control for simultaneously displaying the result of the analysis performed by the analysis unit and the information regarding the thickness of the retinal layer.

9. The information processing apparatus according to claim 8, wherein the display control unit is configured to switch a display method for the information regarding the thickness of the retinal layer based on the information regarding the elongation state.

10. The information processing apparatus according to claim 1, wherein the analysis unit includes a plurality of the trained models, and is configured to select and use at least one trained model from the plurality of the trained models based on the elongation state.

11. The information processing apparatus according to claim 10,
wherein information used for training by the plurality of the trained models includes training information regarding the elongation state of the eyeball, and
wherein the analysis unit is configured to acquire, from each of the plurality of the trained models, distribution information regarding the elongation state included in the training information regarding the elongation state of the eyeball, and to select at least one trained model based on the distribution information and the information regarding the elongation state of the eyeball to be analyzed.

12. The information processing apparatus according to claim 1, wherein the analysis unit is configured to correct, based on the information regarding the elongation state, the information regarding the abnormality in the thickness of the retinal layer which has been output from the trained model.

13. An information processing method comprising:
an elongation information acquisition step of acquiring information regarding an elongation state of an eyeball to be analyzed;
a data acquisition step of acquiring data including information regarding a thickness of a retinal layer of the eyeball; and
an analysis step of analyzing an abnormality in the thickness of the retinal layer based on the information regarding the elongation state and the data including the information regarding the thickness of the retinal layer,
wherein the analysis step includes using a trained model configured to use, as input, at least the data including the information regarding the thickness of the retinal layer to output information regarding the abnormality in the thickness of the retinal layer.

14. A non-transitory storage medium having stored thereon a program for causing a computer to execute the information processing method of claim 13.
